(19) United States
(12) Patent Application Publication
(10) Pub. No.: US 2024/0255647 A1
(43) Pub. Date: Aug. 1, 2024

(54) Sensor Device and Transportation Device

(71) Applicant: Bayerische Motoren Werke Aktiengesellschaft, Muenchen (DE)

(72) Inventor: Jonathan FISCHER, Huettlingen (DE)

(21) Appl. No.: 18/569,254

(22) PCT Filed: Aug. 18, 2022
(86) PCT No.: PCT/EP2022/073019

§ 371 Date: Dec. 12, 2023

(30) Foreign Application Priority Data
Sep. 15, 2021 (DE) 10 2021 123 795.5

(51) Int. Cl. G01S 17/931; F21S 41/20; F21V 9/35; F21W 107/10; F21Y 113/00; G01S 7/481

(52) U.S. Cl. CPC G01S 17/931; F21S 41/285; F21V 9/35; G01S 7/4813; F21W 2107/10; F21Y 2113/30

(57) ABSTRACT

A sensor device for a transportation device includes a sensing apparatus for sensing first electromagnetic radiation having at least one first wavelength, and a covering device for the sensing apparatus. The covering device contains a fluorescent portion includes a fluorescent dye, which has an absorption spectrum and an emission spectrum. The fluorescent portion is transparent to the first electromagnetic radiation having the first wavelength. The fluorescent portion is configured such that, when irradiated with second electromagnetic radiation having a second wavelength in the absorption spectrum of the fluorescent dye, the fluorescent portion emits third electromagnetic radiation in the emission spectrum. The first wavelength and the second wavelength are different.

### BACKGROUND AND SUMMARY

The invention relates to a sensor device for a transportation device, and to a transportation device, in particular a vehicle, having the sensor device.

Modern transportation devices, such as vehicles, for example ground-based vehicles, aircraft and watercraft, use a sensing apparatus with one or more sensors to ascertain relevant information for assistance systems. The sensors can each be covered by a cover so that they are protected from influences of weather, for example insolation, rain or snow, and from rock chip. For this purpose, radar sensors known from the prior art for motor vehicles are usually arranged behind a PVC cover in the region of the front of the motor vehicle.

Optical sensors for sensing electromagnetic radiation in the ultraviolet, visible or near-infrared spectral range, by contrast, may be covered for protection purposes by clear, transparent covering elements such as a windshield of the motor vehicle. By way of example, in this context document DE 10 2017 219 759 A1 describes a lidar sensor device having a housing which accommodates an optical sensor. A first cover hermetically covers the optical sensor together with an optical unit of the sensor, with the result that the elements situated within the housing (optical sensor, optical unit, and electronics) are protected against moisture, dust, and dirt.

Against this background, it is an object of the present invention to provide a sensor device for a transportation device, with this sensor device being configured to emit electromagnetic radiation and the electromagnetic radiation in the case thereof leaving the sensing of further electromagnetic radiation by the sensing apparatus substantially undisturbed. Moreover, it is an object of the present invention to provide a corresponding transportation device.

This object is achieved by a sensor device and a transportation device having the features of the claimed invention.

The sensor device is provided for a transportation device and comprises a sensing apparatus configured to sense first electromagnetic radiation at at least one first wavelength, and a covering device for the sensing apparatus. The covering device has a fluorescent portion with a fluorescent dye which has an absorption spectrum and an emission spectrum. The fluorescent portion is transparent to the first electromagnetic radiation at the first wavelength. Further, the fluorescent portion is configured to emit, upon irradiation with second electromagnetic radiation at a second wavelength in the absorption spectrum of the fluorescent dye, third electromagnetic radiation in the emission spectrum. The first wavelength and the second wavelength are different.

The third electromagnetic radiation preferably is visible fluorescence. Most preferably, the emission spectrum contains a visible part, and the fluorescent portion is accordingly configured to emit the third electromagnetic radiation in the visible part of the emission spectrum upon irradiation of the fluorescent portion with the second electromagnetic radiation at the second wavelength.

The sensor device according to embodiments of the invention advantageously allows relatively simple and flexible emission of the third electromagnetic radiation directly from the covering device. In particular, the third electromagnetic radiation can be emitted from the covering device without needing to be deflected by optical elements such as mirrors or scattering bodies. Since the fluorescent portion of the covering device is transparent to the first electromagnetic radiation which is sensed by the sensing apparatus, the fluorescent portion can be positioned in the beam path of the sensing apparatus without influencing or interfering with the sensing of the first electromagnetic radiation by the sensing apparatus.

The fluorescent dye with the emission spectrum can be excited comparatively easily using invisible (for example, ultraviolet) electromagnetic radiation and can thereupon emit the third electromagnetic radiation, in particular the visible fluorescence, in the beam path of the sensing apparatus. The third electromagnetic radiation is advantageously (re-)emitted in a half space on the side of the covering device opposite to the sensing apparatus. This allows an illuminated design of the covering device and simultaneously synergistically allows dispensing with scattering points or differently designed deflection apparatuses for (visible) light, which potentially interfere with the sensing apparatus, in the covering device, in particular in the beam path of the sensing apparatus.

In the context of the present disclosure, the term “transparent” may mean “transmissive to electromagnetic waves” according to its general definition. In particular, transparent may mean not translucent and, naturally, not opaque. Transparent can mean substantially non-scattering in particular. Transparency preferably requires the propagation direction or/and the intensity of the first electromagnetic radiation to remain substantially unchanged during the passage through the covering device/the fluorescent portion. In the context of this disclosure, substantially means a maximum deviation of no more than 10% or no more than 5%. Thus, in the context of the propagation direction, this may mean a deviation between the angle of incidence and the angle of reflection at the covering device of no more than the aforementioned maximum deviation and, in the context of the intensity of the first electromagnetic radiation during this passage, this may mean a decrease in the intensity along the optical axis of no more than the aforementioned maximum deviation. A transmittance of the fluorescent portion for the first electromagnetic radiation is preferably at least 90% or at least 95% or at least 98%.

In the present context, the term “light” (in particular “fluorescence”) may always mean visible light, which is to say visible electromagnetic radiation. The wavelength of this visible electromagnetic radiation may be located between approx. 380 nm and approx. 780 nm. In the context of the present disclosure, visible should be understood as meaning visible to humans.

The covering device is preferably arranged to cover the sensing apparatus at least in portions such that, in particular, a beam path of the sensor device runs through the covering device, in particular through the fluorescent portion with the fluorescent dye. Preferably, the sensing apparatus is arranged in the sensor device in such a way that it senses the first electromagnetic radiation after the latter has propagated from the surroundings of the sensor device through the covering device, in particular through the fluorescent portion and the fluorescent dye, in the direction of the sensing apparatus and has been incident on the sensing apparatus. The sensing apparatus may have a sensing angle range in which at least a part of the fluorescent portion (with the fluorescent dye) is arranged. Preferably, the fluorescent dye is distributed over the entire fluorescent portion.

The sensing apparatus may be configured not to sense the third electromagnetic radiation in order not to be disturbed when sensing the first electromagnetic radiation. In other words, a sensing wavelength band of the sensing apparatus may be overlap-free vis-à-vis the emission spectrum. To this end, the sensing apparatus may be insensitive to the first electromagnetic radiation and/or may be provided with an appropriate filter for filtering out the third electromagnetic radiation. The filter may be realized electronically (e.g., by way of a plurality of color channels) or as an optical element (for example, as a bandpass filter or band-stop filter). The first electromagnetic radiation to be sensed selectively by the sensing apparatus may be free from (visible) light; the entire first electromagnetic radiation may be invisible. In particular, the sensing apparatus may be restricted to sensing the first electromagnetic radiation. Advantageously, the first electromagnetic radiation is part of a spectral range between 800 nm and 5 μm, most preferably of a spectral range between 800 nm and 3 μm. Accordingly, the first wavelength can be at least 800 nm and/or at most 5 μm, most preferably at least 800 nm and/or at most 3 μm.

The sensing apparatus may contain an optical sensor and/or a radar sensor which, together, may be configured to sense the first electromagnetic radiation. In this case, the optical sensor may be designed for selective sensing of exclusively a first part of the first electromagnetic radiation and, in this case, the radar sensor may be designed for selective sensing of exclusively a second part of the first electromagnetic radiation. The first part of the first electromagnetic radiation can be infrared radiation, in particular near-infrared radiation (preferably in the wavelength range between 880 nm and 930 nm). The second part of the first electromagnetic radiation may contain radar waves, for example at wavelengths between 1 cm and 10 cm. The optical sensor can be, in particular, a camera with a camera image sensor (for example, a CCD or CMOS sensor) or a lidar sensor (“light detection and ranging” sensor). In a further variant, the optical sensor may contain both a camera sensor and a lidar sensor.

The covering device (so-called sensor cover) and in particular the fluorescent portion may be produced from a preferably transparent plastic (for example polycarbonate (PC) or polymethyl methacrylate (PMMA)). In this case, the absorption spectrum and the emission spectrum are preferably no intrinsic spectra of the plastic material, with the result that the third electromagnetic radiation mentioned here/the fluorescence mentioned here does not contain any light on the basis of autofluorescence. Rather, the fluorescent dye is preferably extrinsic and embedded in the fluorescent portion. The fluorescent dye is preferably chosen so that it can be excited to fluoresce by ultraviolet and/or violet radiation and (at least partially) emits in the visible spectral range. The fluorescent dye is advantageously provided in long-term stable fashion and/or in the form of pigments. It may be selected from one of the following families of fluorescent dyes: Alexa Fluor, cyanine, DyLight, fluorescein, FITC, TRITC, rhodamine. For example, the fluorescent dye may be Alexa Fluor™ 350 from Thermo Fischer Scientific, Waltham, MA, USA.

In a particularly preferred variant, the fluorescent dye of the fluorescent portion contains quantum dots, in particular metallic (e.g., gold) quantum dots, but most preferably semiconductor-based quantum dots. In the latter category of quantum dots, in particular, there is no discrete transition between energy levels to be excited, but rather a comparatively broad continuum. The emission spectrum of these quantum dots independently thereof is more narrowband than the absorption spectrum and can be specifically adapted. The quantum dots can be cadmium selenide/zinc selenide (CdSe/ZnSe) quantum dots. For example, such quantum dots are commercially available from SigmaAldrich/Merck under the trade name Lumidot™ They absorb electromagnetic radiation, especially between the near UV and approximately 650 nm. The emission spectrum of these quantum dots has a maximum at 640 nm and a full width at half maximum of less than 40 nm. The quantum dots preferably have a size of between 5 and 8 nm, in particular between 6 and 7 nm.

In particular, the quantum dots may be selected from the group of semiconductor-based core-shell quantum dots. Advantageously, the emission spectrum of these quantum dots can be easily adapted to the respective requirements by selecting the size of the respective quantum dot and the material of the quantum dot. By adapting the refractive index of the material of the fluorescent portion (in particular of the matrix in which the quantum dots are held), it is de facto possible to modify the distances between the energy levels of the electrons, with the result that the energy of a photon emitted in each case during the transition between these energy levels is adapted accordingly. Since the energy levels are inversely proportional to the refractive index, larger refractive indices are accompanied by smaller energies, in terms of absolute value, of the energy levels. Consequently, the emission spectrum can be defined efficiently and easily during the development of the sensor device according to embodiments of the invention.

To excite the fluorescent portion to fluoresce, the sensor device may further contain an illumination apparatus configured and arranged to irradiate the fluorescent portion with the second electromagnetic radiation. To this end, the illumination apparatus preferably contains one or more radiation sources which, in particular, may be directed at the fluorescent portion and the fluorescent dye. In this case, each radiation source may be arranged on the same side of the covering device as the sensing apparatus. This makes it possible to design the sensor device in comparatively compact and integrated fashion, with the result that the illumination apparatus is also protected against influences of weather and rock chip by the covering device. The radiation sources may contain lasers, in particular laser diodes, or light-emitting diodes. Moreover, the illumination apparatus may be configured to scan the second electromagnetic radiation over the covering device.

The illumination apparatus may be arranged relative to the covering device/the fluorescent portion such that the covering device forms a light exit surface that optically masks the sensing apparatus when the illumination apparatus is active. In other words, the sensor device may be designed so that the sensing apparatus is invisibly hidden behind the covering device from a side of the covering device opposite to the sensing apparatus when the third electromagnetic radiation is emitted. Advantageously, the illumination apparatus is in this case aligned relative to the fluorescent portion such that it irradiates the fluorescent portion (in particular in the sensing angle range of the sensing apparatus).

If necessary, the sensor device may moreover comprise a preferably opaque housing, wherein the covering device may be part of the housing, and wherein the sensing apparatus and optionally the illumination apparatus may be arranged in the housing. What this may make possible as a result is that an observer of the sensor device cannot see past the covering device. Alternatively, the covering device may terminate flush with a surface, in particular an external surface, of the transportation device.

The covering device has a multilayer design in a sensor device that can be produced particularly efficiently. In this case, the fluorescent portion may form a layer of the covering device. Moreover, the covering device may contain one or a plurality of any desired ones of the following parts or layers which, starting on one side of the covering device facing the sensing apparatus, are preferably formed successively in the following sequence: a first antireflection layer; a carrier element preferably designed as a substrate layer; a masking layer arrangement; a heating layer; a second antireflection layer; and/or a protection layer. Any desired parts/layers, in particular all of these, may be connected, in particular integrally connected, to one or both of the respectively adjacent parts/layers.

The first antireflection layer may be configured to reduce reflection losses of the first electromagnetic radiation at the surface of the covering device facing the sensing apparatus. In particular, a reflectance (reflectivity) of the first electromagnetic radiation at the surface of the covering device facing the sensing apparatus may be less than 15% or less than 10% or less than 5%. The first antireflection layer is preferably formed directly on the carrier element/the substrate layer. The carrier element is preferably thicker and/or stiffer than the first antireflection layer and/or than the fluorescent portion. Consequently, the carrier element may provide the covering device with mechanical stability. The carrier element may be formed from a plastic (for example, polycarbonate or polymethyl methacrylate) or from glass. The fluorescent portion is preferably formed on a side of the carrier element opposite to the first antireflection layer. The fluorescent portion may be applied to the carrier element as a lacquer or may be connected to the carrier element.

The masking layer arrangement may be formed on the fluorescent portion. It may be provided with one or more translucent or light-opaque first regions. The first regions of the masking layer arrangement may be bounded by one or more second (for example, transparent) regions which have an optically contrasted embodiment vis-à-vis the first regions. In this case, the first regions may form a first layer of the masking layer arrangement; the second regions may form a second layer of the masking layer arrangement. Together, the first regions may represent a pattern, a logo/emblem or an image in front of the background formed by the second regions.

In a preferred variant, the first regions contain color pigments which advantageously absorb some of the third electromagnetic radiation/the fluorescence. If the masking layer arrangement is clearly transparent in the second regions, for example, then a visually perceptible color change may be generated by virtue of the illumination apparatus being switched on. In this case, the third electromagnetic radiation/the fluorescence may be emitted from the covering device unchanged in the second regions (especially if the remainder of the covering device is color-neutral) and in modified fashion in the first regions as a result of absorption of a spectral component of the third electromagnetic radiation or the fluorescence. This allows the pattern/logo/image to be displayed and masked by virtue of respectively activating and deactivating the illumination apparatus. By contrast, if the first regions are non-transmissive to light (opaque/mirroring), then the second regions may represent a background that can be switched on and off.

The heating layer is preferably arranged on a side of the fluorescent portion opposite to the sensing apparatus and consequently advantageously as close as possible to an external surface of the sensor device. It is preferably transmissive to the first electromagnetic radiation and optionally to the third electromagnetic radiation. Particularly preferably, the heating layer is configured to absorb a part of the second electromagnetic radiation in a wavelength range between 1.5 μm and 2.2 μm. In this case, the illumination apparatus is preferably designed to in particular also irradiate the heating layer with the second electromagnetic radiation. In this way, the covering device can be heated such that ice/snow on the covering device can be melted or dew on the covering device can be evaporated. The aforementioned absorption of the part of the second electromagnetic radiation can be realized, for example, by quantum dots with an appropriate absorption spectrum accommodated in the heating layer.

The second antireflection layer preferably has an analogous design to the first antireflection layer and can serve in particular to reduce reflection losses for the first electromagnetic radiation on a side of the heating layer opposite to the sensing apparatus. Finally, the protection layer may be formed on a surface of the covering device opposite to the sensing apparatus. This protection layer is preferably hydrophobic in order to provide a lotus effect for simple cleaning of the covering device. The protection layer is also preferably transparent over a broad bandwidth, in particular to the first, second, and third electromagnetic radiation.

In relation to the first electromagnetic radiation, the covering device, in particular all parts/layers of the covering device, may accordingly have the above-described optical properties of the fluorescent portion. In particular, the covering device as a whole may be transparent to the first electromagnetic radiation at the first wavelength, with the result that the first electromagnetic radiation can be sensed in substantially unimpeded fashion by the sensing apparatus. A transmittance of the entire covering device to the first electromagnetic radiation can be at least 90%, preferably at least 95%. Provision can also be made for interfaces between individual parts/layers of the covering device to be substantially smooth and in particular to have a roughness of Ra<500 μm, at least at the points where the first electromagnetic radiation propagates through the covering device.

The transportation device proposed here comprises a sensor device described in detail above. The transportation device can be a vehicle, in particular a ground-based vehicle, for example a motor vehicle, a watercraft or an aircraft. The sensor device is preferably arranged in the region of an exterior of the transportation device. Moreover, the fluorescent portion is preferably designed such that the third electromagnetic radiation or the fluorescence is emitted at least in part in a direction away from the sensing apparatus. In particular, the covering device can be configured to emit the third electromagnetic radiation outwardly into the surroundings of the transportation device. In a particularly preferred variant, the sensor device is arranged in the region of the front of the transportation device, with the result that the third electromagnetic radiation/the fluorescence can be emitted forwardly relative to the transportation device. In this way, the sensor device can be part of the external illumination of the transportation device, with the result that the transportation device is advantageously better visible in the case of inclement weather and/or in the dark.

The terms “comprising”, “having”, “with”, and the like used in this disclosure should not be construed as exhaustive. In particular, the term “comprising a(n)” means “comprising at least one” in this context. That is to say, “comprising a(n)” does not preclude the presence of further corresponding elements. Rather, the plural (comprising a plurality thereof) is also disclosed here. Further, “at least in portions” in this disclosure may mean “in portions or in full.”

Preferred embodiments of a sensor device for a transportation device and of a transportation device are now explained in more detail with reference to the attached schematic drawings, which are not true to scale.

### BRIEF DESCRIPTION OF THE DRAWINGS

FIG. 1 shows a first embodiment of a sensor device for a transportation device, with the covering device merely having the fluorescent portion in the form of a fluorescent layer.

FIG. 2 shows the covering device of the sensor device from FIG. 1.

FIG. 3 shows the covering device of a second embodiment of a sensor device for a transportation device, with the covering device having a first antireflection layer, a substrate layer, and a masking layer arrangement in addition to the fluorescent portion.

FIG. 4 shows the covering device of a third embodiment of a sensor device for a transportation device, with the covering device having a first antireflection layer, a substrate layer, a masking layer arrangement, a heating layer, a second antireflection layer, and a protection layer in addition to the fluorescent portion.

FIG. 5 shows the covering device of a fourth embodiment of a sensor device for a transportation device, with the covering device having a plurality of layers which overlap one another to a different extent.

FIG. 6 shows a diagram with the absorption spectrum, the emission spectrum, and the spectrum of the first electromagnetic radiation.

FIG. 7 shows an absorption diagram for the covering device from FIG. 4.

FIG. 8 shows a transmission diagram for the covering device from FIG. 4.

FIG. 9 shows a reflection diagram for the covering device from FIG. 4.

FIG. 10 shows an embodiment of a transportation device with the sensor device.

### DETAILED DESCRIPTION OF THE DRAWINGS

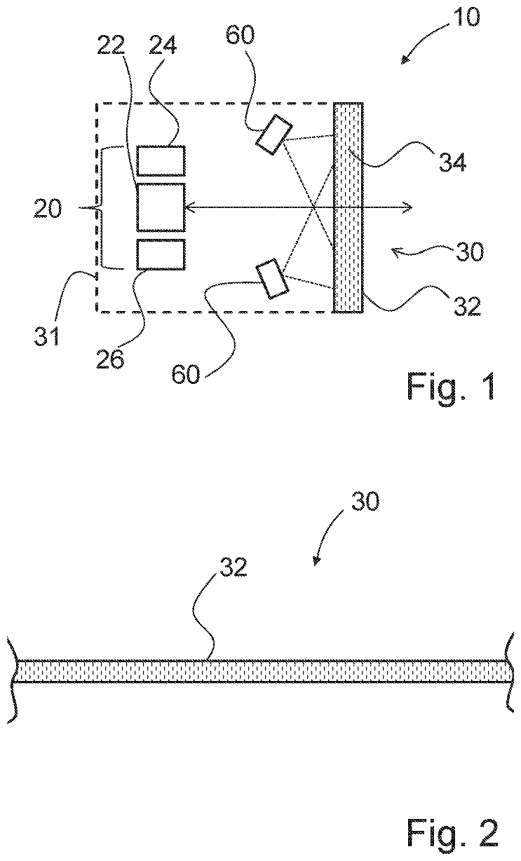

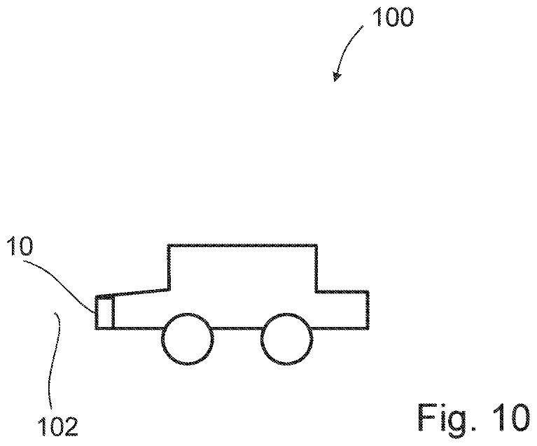

FIGS. 1 and 2 show a sensor device 10 for a transportation device 100 which is shown very schematically in FIG. 10 and which for example is a vehicle in this case. The sensor device 10 contains a sensing apparatus 20 having a lidar sensor 22, a camera sensor 24, and a radar sensor 26 and is configured to sense first electromagnetic radiation at at least one first wavelength 44. Moreover, the sensor device 10 contains a covering device 30 which is arranged in front of the sensing apparatus 20 along a central sensing axis A (optical axis) of the sensing apparatus 20. The covering device 30 is part of a housing 31 defining an interior region I of the sensor device 10 and is arranged in the sensing beam path of the sensing apparatus 20 in particular. Moreover, an illumination apparatus 60 with two radiation sources is provided in the interior region I of the sensor device 10. The radiation sources, when active, irradiate a back surface 36, which faces the sensing apparatus 20, of the covering device 30 with second electromagnetic radiation at a second wavelength 48.

The first electromagnetic radiation propagating from the surroundings of the sensor device 10 along the sensing axis A in the direction of the sensing apparatus 20 to be sensed by the sensing apparatus 20 thus initially passes through a fluorescent portion 32 of the covering device 30 including an extrinsic fluorescent dye 34 present in the fluorescent portion 32 before said electromagnetic radiation reaches the sensing apparatus 20. The covering device 30 in this variant consists of the fluorescent portion 32. In this case, the fluorescent dye 34 can be distributed, in particular distributed homogenously, over the entire fluorescent portion 32. The covering device 30 may be in the form of a plate.

The first electromagnetic radiation contains wavelength bands (so-called working bands) which are each assigned to one or more of the sensors in the sensing apparatus, which is to say can be photoelectrically sensed by the respective sensor. A first wavelength band 45 is located in the near-infrared spectral range and is preferably assigned to the lidar sensor 22. Thus, the lidar sensor 22 can transmit and sense electromagnetic radiation with a first spectrum in the first wavelength band 45 in this case. It is also conceivable that the first wavelength band 45 is additionally assigned to the camera sensor 24, with the result that the radiation in the first wavelength band 45 can also be sensed by the camera sensor 24. The first wavelength band 45 contains the first wavelength 44, which is a peak wavelength (wavelength of a global maximum in the first wavelength band 45) in this case. The first spectrum has a first full width at half maximum. The first wavelength 44 is approx. 905 nm and the first full width at half maximum is approx. 50 nm. Alternatively, the first full width at half maximum can be smaller, for example be 20 nm or 25 nm. Thus, in particular, the camera sensor 24 may sense infrared radiation and/or be part of an infrared camera of the sensor device 10.

A second wavelength band 47 is located in the visible spectral range (380 nm to 780 nm) and is preferably assigned to the camera sensor 24. In this case, the camera sensor 24 can sense electromagnetic radiation with a second spectrum in the second wavelength band 47. The second wavelength band 47 extends from approximately 700 nm to approximately 780 nm, and the second spectrum has a peak wavelength at approx. 700 nm and a full width at half maximum of approx. 50 nm. Alternatively, the first electromagnetic radiation can be substantially invisible. A third wavelength band not depicted in the figures is in the microwave spectral range (wavelength from 1 mm to 1 m), in particular in the spectral range of the centimeter waves (wavelength from 1 cm to 10 cm) and is preferably assigned to the radar sensor 26. The radar sensor 26 is preferably configured to emit and sense radar waves in the third wavelength band (in particular between 2 cm and 5 cm).

The fluorescent dye 34 (here Alexa Fluor™ 350 by Thermo Fischer Scientific, by way of example) has an absorption spectrum 42 and an emission spectrum 46. The absorption spectrum 42 has a maximum at the second wavelength 48, by way of example 346 nm in this case, and the emission spectrum 46 has a maximum at a third wavelength 49 in the visible spectral range (at 444 nm here), and consequently in the visible part 50 of the emission spectrum 46. The full width at half maximum of the absorption spectrum 42 and the full width at half maximum of the emission spectrum 46 are approx. 50 nm in each case. Thus, if the fluorescent portion 32 is irradiated with the second electromagnetic radiation in the absorption spectrum 42 of the fluorescent dye 34, then the fluorescent portion emits the third electromagnetic radiation, here in the form of visible fluorescence, in the visible part 50 of the emission spectrum 46. In particular, this third electromagnetic radiation is emitted to the right in FIG. 1, which is to say to a side of the covering device 30 opposite to the sensing apparatus 20, with the result that the covering device 30 is better visible, especially in darkness.

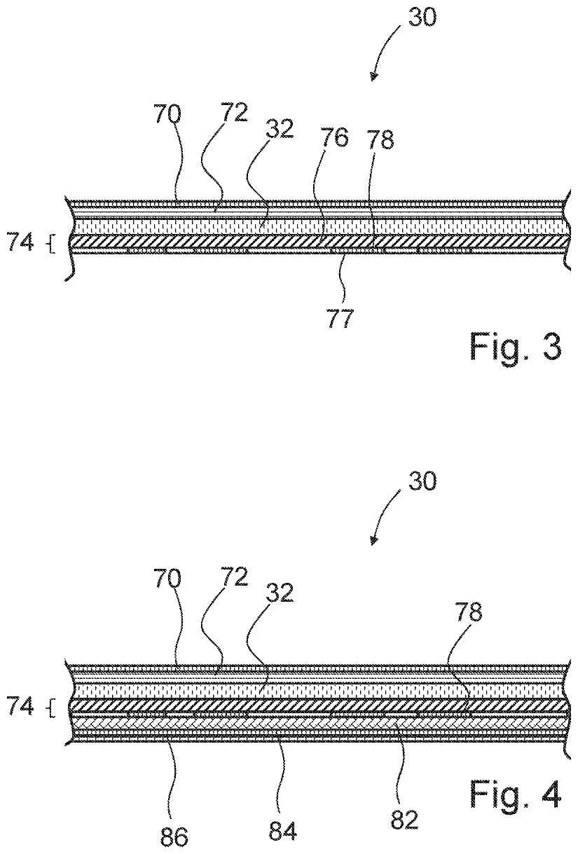

A covering device 30, shown in FIG. 3, of a further sensor device 10 differs from the covering device 30 from FIG. 2 in that the former has a multi-layer embodiment. Starting from a side of the covering device 30 facing the sensing apparatus 20 (at the top in FIG. 3), the covering device 30 contains a first antireflection layer 70 on the surface of the covering device 30 delimiting the interior region I. The first antireflection layer 70 is configured to reduce a reflectance to the first electromagnetic radiation at the surface of the covering device 30 to a value below 5%, in particular below 2%.

On the outer side, the first antireflection layer 70 is adjoined by a carrier element 72 in the form of a substrate layer which may have the greatest thickness and/or stiffness of all parts/layers of the covering device 30 of FIG. 3, in order to serve as supporting structure for the fluorescent portion 32. The first antireflection layer 70, the carrier element 72, and the second antireflection layer 84, described in more detail below, for the first electromagnetic radiation, and the protection layer 86 are preferably transparent over a broad bandwidth, in particular over the first wavelength band, the second wavelength band, and/or over a wavelength band defined by the absorption spectrum and the emission spectrum.

The fluorescent portion which is described in detail above and formed here as a fluorescent layer is arranged on the carrier element 72. A masking layer arrangement 74 with a first layer 77 and a second layer 76 is located on a side of the fluorescent portion 32 opposite to the carrier element 72. The first layer 77 is designed as a contrast color layer with a plurality of light-opaque regions 78, while the second layer 76 is designed as a transparent color layer which is configured in this example to absorb light outside of the emission spectrum.

Additionally, the covering device 30 from FIG. 3 that is shown has all the features of the covering device 30 from FIG. 2.

A covering device 30, shown in FIG. 4, of a further sensor device 10 differs from the covering device 30 from FIG. 3 in that the former has (on the outside in this case) a heating layer 82, which absorbs the second electromagnetic radiation, on the masking layer arrangement 74, said heating layer otherwise being transparent to the first electromagnetic radiation and to the third electromagnetic radiation (the fluorescence) like the remainder of the covering device. The heating layer 82 is provided with a component, for example in the form of suitable quantum dots, which absorbs radiation in a fourth wavelength band 52 between 1600 nm and 2000 nm. This allows the covering device 30 to be heated wirelessly by electromagnetic radiation. Finally, a second antireflection layer 84 for the first electromagnetic radiation and a hydrophobic (so-called “easy to clean”) protection layer 86 are formed on a surface of the heating layer 82 opposite to the sensing apparatus 20.

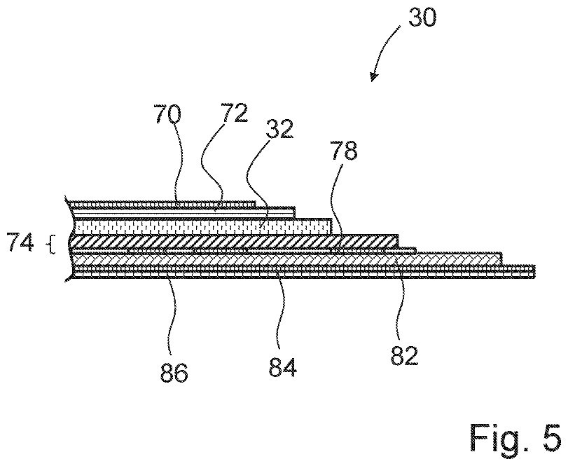

Moreover, the covering device 30 shown in FIG. 4 has all features of the covering device 30 from FIGS. 2 and 3. A further modification of the covering device 30 from FIG. 4 is shown in FIG. 5. In this modification, the extent of the layers/elements of the covering device 30 varies perpendicular to the optical axis. Preferably, the protection layer 86 and the second antireflection layer 84 extend laterally over all other layers of the covering device 30, in order to protectively cover the latter.

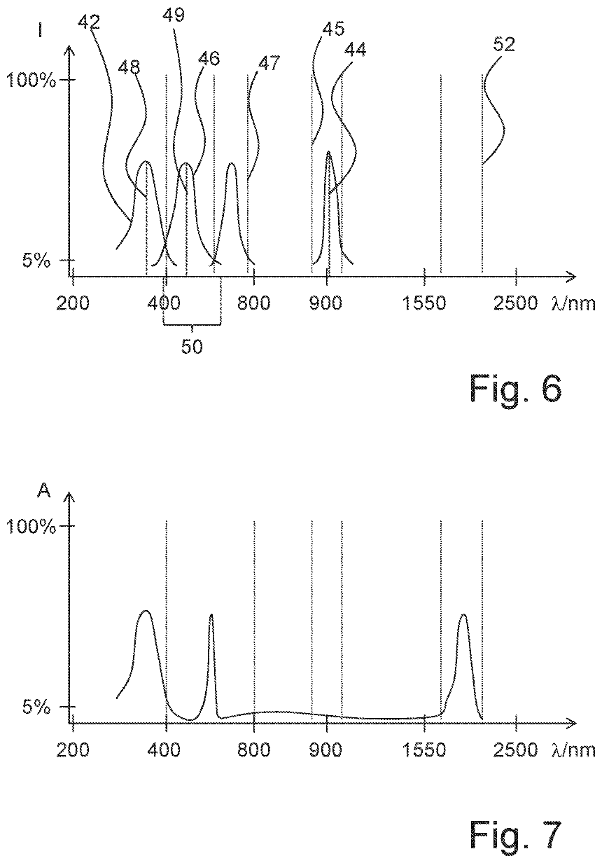

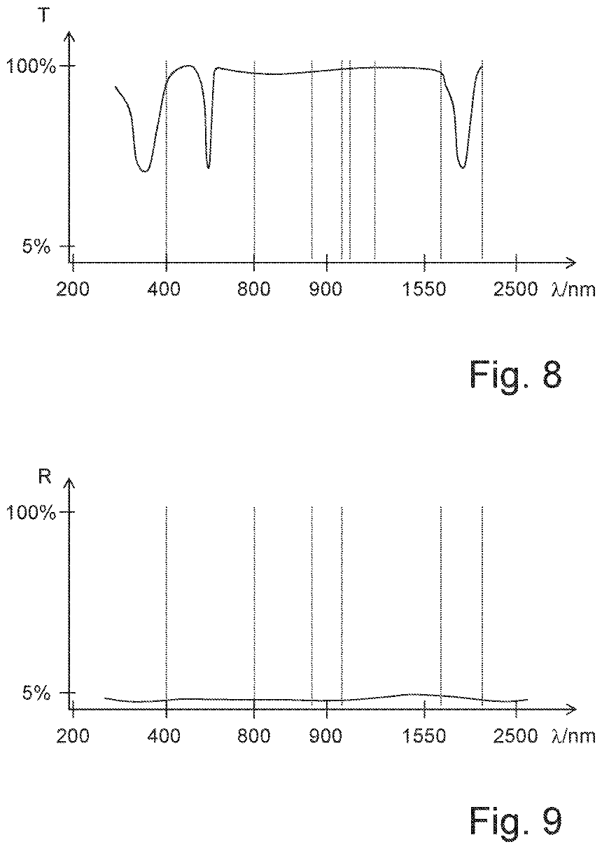

FIGS. 6 to 9 show diagrams of the intensity of the electromagnetic radiation, and of the absorptance, the transmittance, and the reflectance of the covering device 30 from FIG. 4 (outside the light-opaque regions 78). It is evident from these diagrams that the radiated-in first electromagnetic radiation can propagate virtually without losses/without damping through the covering device 30 (cf. transmittance in FIG. 8), especially in the first wavelength band 45 and in the second wavelength band 47. The same applies to the third electromagnetic radiation which is emitted by the fluorescent dye 34 upon absorption of the radiation in the absorption spectrum (cf. peak to the left in FIG. 6). The reflection is kept low due to the two antireflection layers 70, 84 (cf. FIG. 9).

FIG. 10 finally shows the transportation device 100 (vehicle). This transportation device 100 contains the sensor device 10 in the region of the front of the transportation device 100. In particular, the sensor device may be arranged (for example, on the front) below the front opening of the transportation device 100 or behind a front screen of the transportation device 100. Preferably, the third electromagnetic radiation as the fluorescence is emitted forward in the direction of travel when the sensor device 10 is arranged in the region of an exterior of the transportation device 100. However, it is also conceivable to use the sensor device 10 to sense first electromagnetic radiation from the interior of the transportation device 100, wherein the sensor device 10 would accordingly be arranged in the region of the interior.

1.-10. (canceled)

11. A sensor device for a transportation device, the sensor device comprising:
a sensing apparatus for sensing first electromagnetic radiation at at least one first wavelength; and
a covering device for the sensing apparatus, the covering device containing a fluorescent portion with a fluorescent dye which has an absorption spectrum and an emission spectrum, wherein:
the fluorescent portion is transparent to the first electromagnetic radiation at the first wavelength,
the fluorescent portion is configured to emit, upon irradiation with second electromagnetic radiation at a second wavelength in the absorption spectrum of the fluorescent dye, third electromagnetic radiation in the emission spectrum, and
the first wavelength and the second wavelength are different.

12. The sensor device according to claim 11, wherein:
the sensing apparatus has an optical sensor and/or a radar sensor, and/or
the sensing apparatus is configured to sense the first electromagnetic radiation when the first electromagnetic radiation propagates through the fluorescent portion in a direction of the sensing apparatus and is incident on the sensing apparatus.

13. The sensor device according to claim 12, wherein the optical sensor is a lidar sensor and/or a camera sensor.

14. The sensor device according to claim 11, wherein:
the first electromagnetic radiation is invisible,
the first electromagnetic radiation contains infrared radiation and/or radar waves, and/or
the first wavelength is at least 800 nm and/or at most 5 μm.

15. The sensor device according to claim 11, wherein:
the second electromagnetic radiation is invisible,
the second wavelength is at most 400 nm or at most 380 nanometers, and/or
the second electromagnetic radiation is UV radiation.

16. The sensor device according to claim 11, wherein:
a transmittance of the fluorescent portion for the first electromagnetic radiation is at least 90%, and/or
the fluorescent portion is configured as a layer of the covering device.

17. The sensor device according to claim 11, wherein:
a transmittance of the fluorescent portion for the first electromagnetic radiation is at least 95%, and/or
the fluorescent portion is configured as a layer of the covering device.

18. The sensor device according to claim 11, wherein:
a transmittance of the fluorescent portion for the first electromagnetic radiation is at least 98%, and/or
the fluorescent portion is configured as a layer of the covering device.

19. The sensor device according to claim 11, wherein:
the emission spectrum has a visible part and the fluorescent portion is configured to emit, upon irradiation of the fluorescent portion with the second electromagnetic radiation at the second wavelength, the third electromagnetic radiation in the visible part of the emission spectrum,
the third electromagnetic radiation is visible fluorescence,
the fluorescent dye of the fluorescent portion is extrinsic, and/or
the fluorescent dye of the fluorescent portion contains quantum dots.

20. The sensor device according to claim 11, further comprising:
an illumination apparatus arranged to irradiate the fluorescent portion with the second electromagnetic radiation.

21. The sensor device according to claim 20, wherein the illumination apparatus is arranged on a same side of the covering device as the sensing apparatus.

22. The sensor device according to claim 11, wherein:
the covering device has a multilayered design, and/or
the covering device further comprises one or more of:
a first antireflection layer for the first electromagnetic radiation,
a carrier element for carrying the fluorescent portion,
a masking layer arrangement having one or more light-opaque regions;
a heating layer which is transparent to the first electromagnetic radiation,
a second antireflection layer for the first electromagnetic radiation, or
a protection layer on a surface of the covering device opposite the sensing apparatus.

23. The sensor device according to claim 22, wherein the antireflection layer is formed on a surface of the covering device facing the sensing apparatus.

24. The sensor device according to claim 22, wherein the carrier element is embodied as a substrate layer.

25. The sensor device according to claim 22, wherein the heating layer is transparent to the third electromagnetic radiation.

26. The sensor device according to claim 22, wherein the second antireflection layer is arranged on a side of the fluorescent portion opposite the sensing apparatus.

27. The sensor device according to claim 22, wherein the protection layer is hydrophobic.

28. A transportation device comprising the sensor device according to claim 11.

29. A transportation device comprising the sensor device according to claim 28, wherein the transportation device is a vehicle.

30. The transportation device according to claim 28, wherein the sensor device is arranged in a region of an exterior of the transportation device, such that the covering device is configured to transmit the third electromagnetic radiation into the surroundings of the transportation device
